(19) United States
(12) Patent Application Publication
(10) Pub. No.: US 2007/0116251 A1
(43) Pub. Date: May 24, 2007

(54) Method system and terminal for providing customized information during call setup process in telecommunication system

(76) Inventor: Weon Ho Seo, Daejeon (KR)

Correspondence Address: BRUCE E. LILLING;LILLING & LILLING PLLC, P.O. BOX 560, GOLDEN BRIDGE, NY, 10526, US

(21) Appl. No.: 10/595,052

(22) PCT Filed: Jul. 16, 2004
(86) PCT No.: PCT/KR04/01773

§ 371 Date: Jan. 18, 2006

(30) Foreign Application Priority Data
Jan. 19, 2004 (KR) 1020040003907
Jul. 19, 2003 (KR) 102003049511

(51) Int. Cl. H04M 1/00; H04M 3/00

(52) U.S. Cl. 379/372

(57) ABSTRACT

The present invention includes method and systems, and communication terminal, for transmitting a variety of information and contents (Ring-Back Information) such as music, songs, advertisements, sounds, voices, any audible resource edited by the subscriber, animation, and moving images, instead of the uniform ring-back tone (an mechanical tone) which has been provided to a calling party while the calling party is waiting for the called party's answer after the calling party executes a call setup request.

According to the invention, the Ring-Back Information selected by the called party is provided to the calling party by inter-working of the terminating exchange 10-n and the terminating terminal 20-n. When the terminating terminal 20-n receives a call from the terminating exchange 10-n, the terminating terminal 20-n transmits the Ring-Back Information to the terminating exchange and then the terminating exchange 10-n delivers to the originating terminal the Ring-Back Information received from the terminating terminal 20-n.

### TECHNICAL FIELD

The present invention relates to a communication system, especially to methods, systems and communication terminals for transmitting a variety of information and contents (hereinafter called collectively as “Ring-Back Information” or “RBI”), instead of ring-back tone(mechanical tone) while the calling party is waiting for a called party's answer after the calling party executes a call setup request.

### BACKGROUND ART

In general, when a calling party executes a call setup request in wired network such as PSTN (Public Switched Telephone Network) and wireless network such as PLMN (Public Land Mobile Network), the network informs the calling party that the call request is now underway by transmitting the ring-back tone to the calling party. It takes normally about 10 seconds or more until the called party answers the call received from the calling party.

Based on the above-mentioned situation, there have been several attempts to provide useful information for the calling party during the call setup period. Patent No. 2000-244 (title: Method and system for providing the alternative ring-back tone predetermined by the called party at the terminating exchange in the wired and the wireless networks) and Patent 2001-108937 (title: Method and system for generating call origination tone in the mobile system) of Republic of Korea mention the system that provides a variety of information for the calling party during the above-mentioned call setup period, instead of ring-back tone.

According to those patents, there should be additional equipment or systems for providing a variety of information (or ring-back tones) for the calling party, by inter-working with switching systems.

In other words, in configuring the systems for those patents, additional equipment or systems should be required and also the software of the switching network should be upgraded, and it requires enormous efforts and expenses to furnish the service.

### DISCLOSURE OF INVENTION

Accordingly, the present invention is created to overcome the above-mentioned problems, and includes methods, systems and communication terminals for transmitting the Ring-Back Information (RBI) such as music, songs, advertisements, sounds, voices, any audible resource edited by the subscriber, animation, and moving images during the call setup period, only with the minimized change of communication network.

With respect to the first aspect to accomplish the purpose of the present invention, the method for providing the RBI during the call setup time in the communication system that includes a number of terminals and exchanges consists of the steps of: a call setup request is received from the originating terminal; the switching network notifies the terminating terminal that a call request is underway, in response to the call request from the originating terminal; the terminating terminal transmits the RBI to the switching network; and the network transfers to the originating terminal the RBI received from the terminating terminal.

With respect to the second aspect to accomplish the purpose of the present invention, the system for providing the RBI during the call setup time (hereinafter called as “RBI System’) consists of a number of terminals and the switching network that controls connection of the communication path between terminals. When a terminal receives a call request from other terminal, the terminating terminal transmits the RBI to the switching network by the time the called party answers the call and the switching network deliver to the originating terminal the RBI received from the terminating terminal.

With respect to the third aspect to accomplish the purpose of the present invention, the communication terminal for providing the RBI during the call setup time consists of: sound input means; sound output means; key input means to input telephone numbers; the interface to connect with the communication network; storage means for storing the RBI; and control means for controlling the transmission of RBI stored in the above storage means to the communication network, when there is a call request from the communication network.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a block diagram showing the configuration of a general telecommunication network;

FIG. 2 is a call flow showing the general call processing procedures between terminals in a general ISDN network;

FIG. 3 is a call flow showing an example of call processing procedures between terminals, in case the present invention is applied to an ISDN network;

FIG. 4a and FIG. 4b are message formats showing an example of configuration of IBI Request Message and IBI Response Message in FIG. 3 respectively;

FIG. 5 is a call flow showing other example of call processing procedures between terminals, in case the present invention is applied to an ISDN network;

FIG. 6a and FIG. 6b are parameter formats showing an example of configuration of IBI Request Indicator and IBI Response Indicator respectively which are exchanged between the terminating exchange (10-n) and the terminating terminal in FIG. 5;

FIG. 7 is an example of call processing procedures between a terminating exchange and a terminating terminal, in case the present invention is applied to a mobile telecommunication network;

FIG. 8a˜8d are message formats showing an example of configuration of IBI Request Message, IBI Requested Message, IBI Response Message and IBI Responded Message in FIG. 7 respectively;

FIG. 9 is other example of call processing procedures between a terminating exchange and a terminating terminal, in case the present invention is applied to a mobile telecommunication network;

FIG. 10a and FIG. 10b are parameter formats showing an example of configuration of IBI Request Indicator and IBI Response Indicator in FIG. 9 respectively; and

FIG. 11 is a block diagram showing an example of internal configuration of terminal, in case the present invention is applied.

### BEST MODE FOR CARRYING OUT THE INVENTION

Reference will now be made in detail to the preferred embodiments of the present invention, examples of which are illustrated in the accompanying drawings.

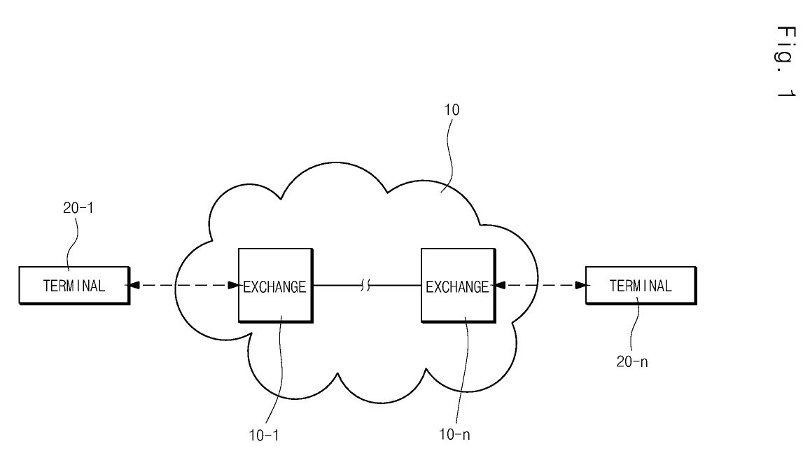

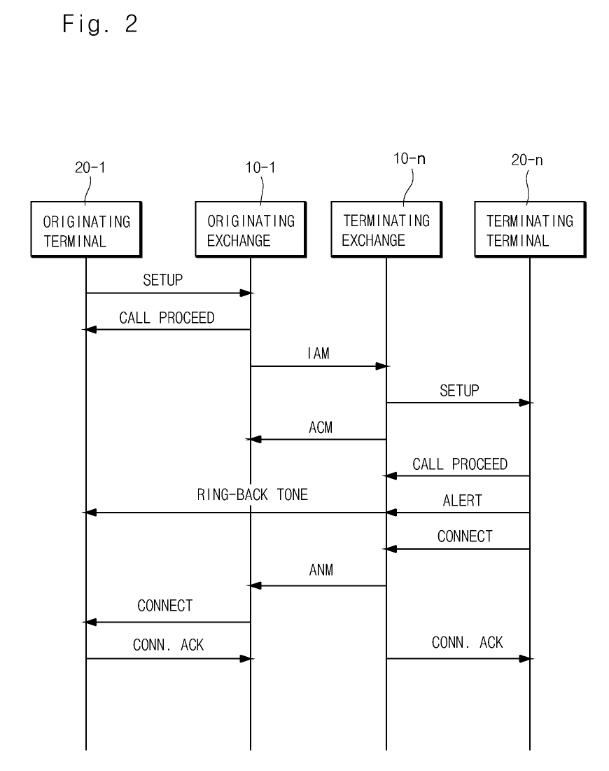

First of all, referring to FIG. 1 and FIG. 2, the basic concept of the invention is described as below.

FIG. 1 is a general configuration of telecommunication system to which the present invention is applied. As a switching network providing the communication service between subscribers of PLNM, PSTN or VoIP, the reference numeral 10 in FIG. 1 is composed of lots of exchanges 10-1, . . . , 10-n. And the reference numeral 20 (20-1˜20-n) are terminals which are connected to the above-mentioned switching network 10 through wireless or wired interface and with which users can transmit and receive information through the above-mentioned switching network 10.

The basic concept of the present invention is described as an example of call completion procedure from the terminal 20-1 to the terminal 20-n as shown in the FIG. 1. Also, the present invention can be applicable to both existing wired and wireless communication networks in the same manners. In the FIG. 2, the basic concept of the present invention is described, based on ISDN (Integrated Services Digital Network).

When the terminal 20-1 sends to the exchange 10-1 in the switching network 10 a call setup request for the terminal 20-n, the exchange 10-1 becomes an originating exchange, while the exchange 10-n becomes a terminating exchange. Practically, the originating exchange and the terminating exchange may be the same, and there may be one transit exchange or more between the originating exchange and the terminating exchange.

When a calling party executes a call setup request using a terminal 20-1, the Setup Message in which a terminating number is included is transmitted from the terminal 20-1 to the originating exchange 10-1, and in response to the Setup Message, the originating exchange 10-1 executes an originating call process, for example, by transmitting the Call Proceeding Message to the terminal 10-1.

Subsequently, the originating exchange 10-1 creates an Initial Address Message (IAM) on the basis of the above-mentioned Setup Message and transmits it to the terminating exchange 10-n. The terminating exchange 10-n starts the terminating call process by transmitting an Address Complete Message (ACM) to the originating exchange 10-1 and by transmitting a Setup Message to the terminal 20-n at the same time.

Meanwhile, when the terminating terminal 20-n receives a Setup Message from the terminating exchange 10-n, the terminating terminal 20-n transmits a Call Proceeding Message to the terminating exchange 10-n and informs the called party that a call request is received by generating a ring tone. Then the terminating terminal 20-n transmits an Alert Message, indicating that a call is presently in process, to the terminating exchange 10-n. The terminating exchange 10-n transmits the ring-back tone toward the calling party based on the Alert Message notifying the originating terminal that the call is being processed at the terminating terminal 20-n.

When the called party answers the call, the terminating terminal 20-n transmits a Connect Message to the terminating exchange 10-n. Then the terminating exchange 10-n transmits an Answer Message (ANM) toward the originating exchange 10-1. The originating exchange 10-1 transmits the Connect Message, indicating that the called party has answered the call, to the originating terminal 20-1, and connects the call paths so that the communication between the originating terminal 20-1 and the terminating terminal 20-n can be possible. In the FIG. 2, CONN.ACK means Connect Acknowledgement, a confirmation message to the above-mentioned Connect Message.

When a call request is received from an originating terminal 20-1 in the general communication system, the terminating exchange 10-n as stated above, the originating exchange 10-1 or additional equipment (or system) that is linked to the originating exchange 10-1 or to the terminating exchange 10-n furnishes the originating terminal 20-1 with a kind of Ring-Back Information. In the present invention, however, it is the terminating terminal 20-n that furnishes the originating terminal 20-1 with such Ring-Back Information directly, instead of the terminating exchange 10-n or such additional equipment (or system).

In the present invention, the Ring-Back Information is provided to the originating terminal 20-1 by inter-working between the terminating terminal 20-n and the terminating exchange 10-n. The inter-working method between the terminating terminal 20-n and the terminating exchange 10-n is to exchange messages between the terminating terminal 20-n and the terminating exchange 10-n, where the exchange of messages can be considered in two ways; one is by using the existing messages and the other is by defining new messages. Of course, if the communication network requires that the terminating terminal 20-n should furnish the Ring-Back Information all the time, such inter-working of messages is unnecessary and the terminating terminal 20-n will provide the Ring-Back Information unconditionally toward the terminating exchange 10-n.

As stated above, if the terminating terminal 20-n furnishes the Ring-Back Information, a variety of communication value-added services can be provided to the called party:

1. The called party can provide the calling party with Ring-Back Information that the called party wants. The Ring-Back Information includes a variety of information or contents such as music, songs, advertisements, sounds, voices, any audible resource edited by the subscriber, animation, moving images and so on, instead of the simple ring-back tone.

2. When the terminating exchange 10-n provides the terminating terminal 20-n with the caller's number, for example, like the CLIP (Calling Line Identification Presentation) service, it is possible that the terminating terminal 20-n provides different RBI according to the caller's number.

3. In case the called party cannot answer the call for whatsoever reasons, the called party can, at his option, give a variety of announcements, in response to the call request from the calling party.

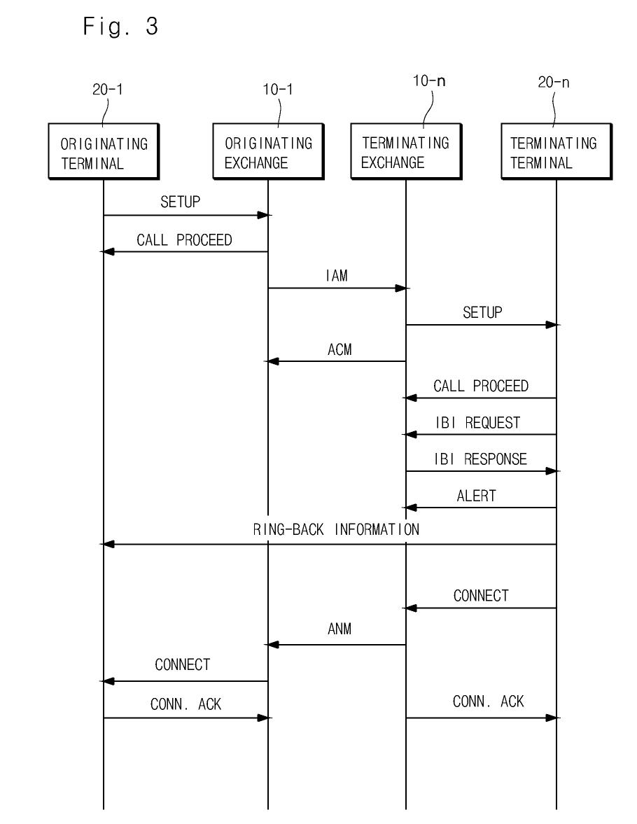

FIG. 3 is a call flow showing a call processing procedure in case the present invention is applied to the ISDN. This shows an example of inter-working between the terminating exchange 10-n and the terminating terminal 20-n where new messages are introduced between the terminating exchange 10-n and the terminating terminal 20-n. The detailed explanation is skipped, regarding the parts in FIG. 3 that are practically same as those stated in FIG. 2.

Upon receiving a Setup Message from the terminating exchange 10-n, the terminating terminal 20-n transmits a Call Proceeding Message to the terminating exchange 10-n as shown in FIG. 3. And the terminating terminal 20-n checks whether the transmission function of Ring-Back Information is presently activated. If the function is activated, the terminating terminal 20-n transmits to the terminating exchange 10-n an In-Band Information (IBI) Request Message indicating its intention of transmitting the RBI to the originating terminal 20-1 directly.

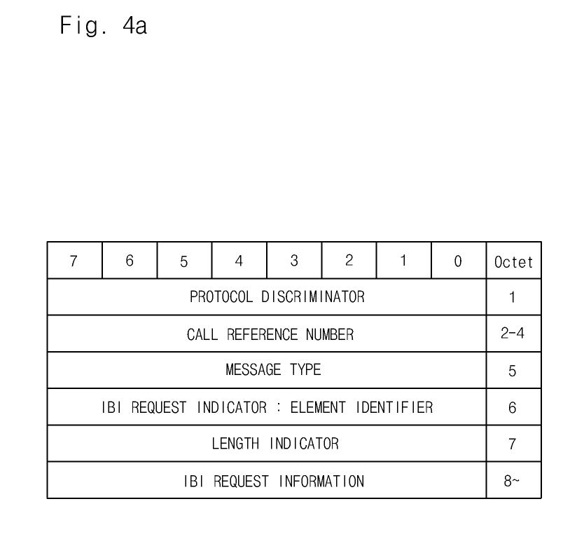

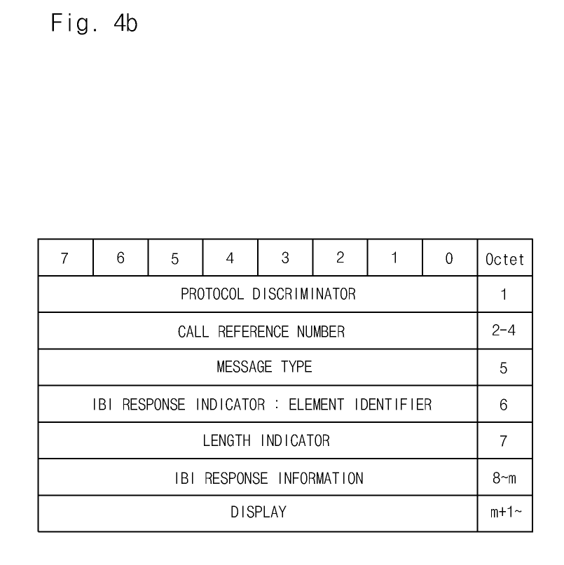

FIG. 4a is a message format showing an example of configuration of IBI Request Message. This is based on the specifications of ITU-T Q.931. As a normal message, the IBI Request Message in FIG. 4a contains 1 byte of Protocol Discriminator, 2 or 3 bytes of Call Reference and 1 byte of Message Type. A peculiar value is allotted to the Message Type field indicating that the message concerned is IBI Request Message. And the IBI Request Indicator is included in it. The IBI Request Indicator contains Element Identifier, Length Indicator and IBI Request Information. The IBI Request Information field may contain an RBI type that will be transmitted from the terminating terminal 20-n.

When receiving an IBI Request Message from the terminating terminal 20-n, the terminating exchange 10-n decides whether it permits the transmission of the RBI by the terminating terminal 20-n, forms an IBI Response Message including the permission information, and transmits it to the terminating terminal 20-n. The decision is usually based on the inquiry to the subscriber's profile information indicating whether the terminating terminal 20-n is registered in the service concerned.

FIG. 4b is a message format showing an example of configuration of IBI Response Message in accordance with specifications of ITU-T Q.931. The IBI Response Message in FIG. 4b also contains a Protocol Discriminator, a Call Reference and a Message Type. A peculiar value indicating that the message concerned is IBI Response Message is allotted to the Message Type field. And the IBI Response Indicator and the Display Information are included in it.

This IBI Response Indicator contains Element Identifier, Length Indicator and IBI Response Information. The IBI Response Information field basically indicates whether the transmission of RBI by the terminating terminal 20-n is allowed and, optionally, the RBI types allowed. In addition, the Display Information above may contain the calling party's number or the information indicating that the transmission of RBI is allowed or rejected.

If the terminating terminal 20-n is not subscribed to the service, the terminating exchange 10-n transmits to the terminating terminal 20-n the IBI Response Message indicating the transmission of RBI is rejected. And when receiving an Alert Message from the terminating terminal 20-n, the terminating exchange 10-n generates the ring-back tone and transmits it toward the originating terminal 20-1 in the normal manner.

On the other hand, if the terminating terminal 20-n is normally subscribed to the service, the terminating exchange 10-n sends to the terminating terminal 20-n the IBI Response Message that the transmission of RBI is allowed. And when receiving an Alert Message from the terminating terminal 20-n, it delivers the RBI received from the terminating terminal 20-n toward the originating terminal 20-1 by connecting the traffic channel from the terminating terminal 20-n toward the originating terminal 20-1. In this case, of course, the terminating exchange 10-n prevents connecting the traffic channel from the originating terminal 20-1 toward the terminating terminal 20-n in order not to allow the possibility that the called party and the calling party communicate with each other during the RBI time.

And when receiving from the terminating exchange 10-n the IBI Response Message that the transmission of RBI is permitted, the terminating terminal 20-n informs the called party of the fact that a call request is present by generating a ringing signal and at the same time transmits to the terminating exchange 10-n an Alert Message indicating that the ringing is now underway, and subsequently extracts an RBI from the storage in it and transmits it to the terminating exchange 10-n. As stated above, the RBI may be any information or contents such as music, songs, advertisements, sounds, any audible resource edited by the subscriber, voices, animation and moving images, and one or more RBI resources that the called party selects are stored in the terminal in advance as a substitute for the simple existing ring-back tone.

On the other hand, when receiving from the terminating exchange 10-n the IBI Response Message indicating the transmission of RBI is rejected, the terminating terminal 20-n merely performs the general call processing procedures generating a ringing signal to the user and transmitting an Alert Message to the terminating exchange 10-n. In this case, of course, the terminating terminal 20-n may give the user a notice that the transmission of RBI is rejected.

And the procedures hereafter are executed in the same manner as the common procedures.

As a result, when the terminating terminal 20-n receives a call request from the originating terminal 20-1, the terminating terminal 20-n can transmit the RBI toward the originating terminal 20-1 instead of the Ring-back Tone by the terminating exchange 10-n, and the called party can provide the calling party with the RBI selected by the called party.

In addition, according to the present invention, all the terminating exchange 10-n has to do is only to deliver the RBI received from the terminating terminal 20-n toward the originating terminal 20-1. The RBI Service, therefore, can be possible without any additional equipment or system and without a large scale of software upgrade in the existing system.

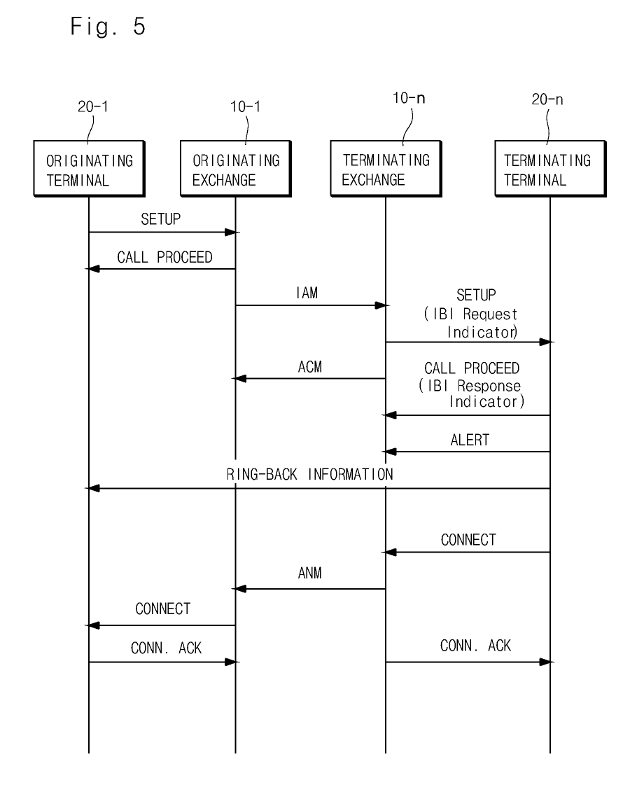

FIG. 5 is a call flow showing other example of call processing procedures in case the present invention is applied to ISDN. This is an example of inter-working between the terminating exchange 10-n and the terminating terminal 20-n, using the existing messages exchanged between the terminating exchange 10-n and the terminating terminal 20-n.

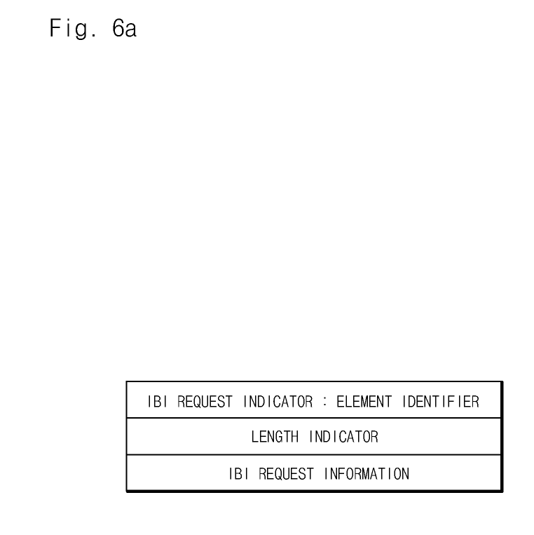

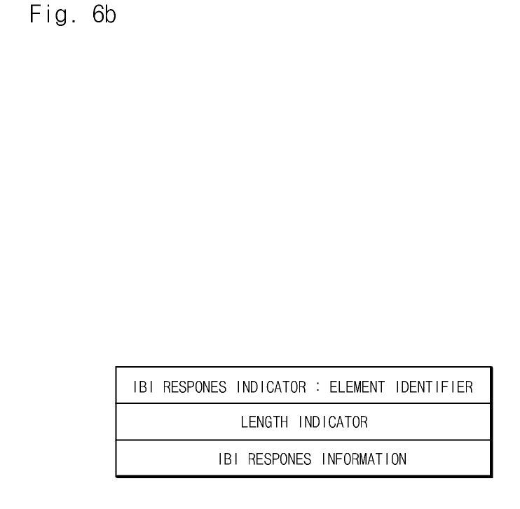

As shown in FIG. 5, the Setup Message transmitted from the terminating exchange 10-n to the terminating terminal 20-n contains an IBI Request Indicator requesting the terminating terminal 20-n to transmit the RBI. FIG. 6a is an example of configuration of IBI Request Indicator that is included in the Setup Message. As shown in FIG. 6a, the IBI Request Indicator contains Element Identifier indicating the type of information element, Length Indicator indicating the total length of the element, and IBI Request Information indicating the request or the query to the terminating terminal 20-n to transmit the RBI. The IBI Request Information may also contain the allowed RBI types that can be transmitted from the terminating terminal 20-n.

As shown in FIG. 5, when receiving an IAM from the originating exchange 10-1, the terminating exchange 10-n judges whether the called party concerned is a subscriber of RBI service and, if it is, what kind of RBI is permitted by inquiring into the subscriber's profile information based on the called party number. And if it is confirmed that the called party is an RBI service subscriber, the Setup Message in which IBI Request Indicator is included is transmitted to the terminating terminal 20-n. Here, it is desirable that the Setup Message includes the IBI Request Indicator only if the terminal is subscribed to the RBI service.

Meanwhile, the terminating terminal 20-n includes IBI Response Indicator in the Call Proceeding Message as a response to the IBI Request Indicator, and transmits it to the terminating exchange 10-n. FIG. 6b is an example of configuration of IBI Response Indicator that is included in the Call Proceeding Message. As shown in FIG. 6b, the IBI Request Indicator contains Element Identifier indicating the type of information element, Length Indicator indicating the total length of the element, and IBI Response Information indicating whether the terminating terminal 20-n will transmit the RBI. The IBI Response Information can also contain the detailed information on the RBI types that will be transmitted from the terminating terminal 20-n.

When receiving the Setup Message with IBI Request Indicator from the terminating exchange 10-n, the terminating terminal 20-n judges whether it shall provide the RBI. And in case the terminating terminal 20-n shall provide the RBI, the terminating terminal 20-n forms the Call Proceeding Message in which the IBI Response Indicator is included and transmits it to the terminating exchange 10-n, if the terminating terminal 20-n can generate the RBI. The judgment on availability of RBI is based on whether the RBI is now stored and available in the terminal and whether the RBI function is activated by the user.

After transmitting the Call Proceeding Message to the terminating exchange 10-n, the terminating terminal 20-n informs the user that the call request is underway by generating the ring tone and transmits the Alert Message to the terminating exchange 10-n. And in case the terminating terminal 20-n itself shall provide the RBI, the terminating terminal 20-n extracts the RBI from the RBI storage and transmits it to the terminating exchange 10-n. The next procedures are the same as the normal ones.

In addition, when receiving the Call Proceeding Message from the terminating terminal 20-n, the terminating exchange 10-n judges whether the terminating exchange 10-n itself should generate and transmit the Ring-back Tone to the originating terminal 20-1 or the terminating exchange 10-n should deliver the RBI from the terminating terminal 20-n to the originating terminal 20-1, based on the IBI Response Indicator included in the Call Proceeding Message.

In case the terminating exchange 10-n should deliver the RBI from the terminating terminal 20-n to the originating terminal 20-1, the terminating exchange 10-n connects the traffic channel from the terminating terminal 20-n toward the originating terminal 20-1, as described in the description of FIG. 3.

In this case, of course, the terminating exchange 10-n prevents connecting the traffic channel from the originating terminal 20-1 toward the terminating terminal 20-n in order not to allow the possibility that the called party and the calling party communicate with each other during the RBI time. In case the terminating exchange 10-n itself should generate and transmit the ring-back tone to the originating terminal 20-1, the terminating exchange 10-n transmits the ring-back tone toward the originating terminal 10-1 in response to the Alert Message from the terminating terminal 20-n, as normal.

In this application example, the terminating terminal 20-n can provide the RBI, using the existing messages: Setup Message and Call Proceeding Message. Therefore, there is no possibility of delay in the call setup between the originating terminal 20-1 and the terminating terminal 20-n due to the addition of messages exchanged between the terminating exchange 10-n and the terminating terminal 20-n.

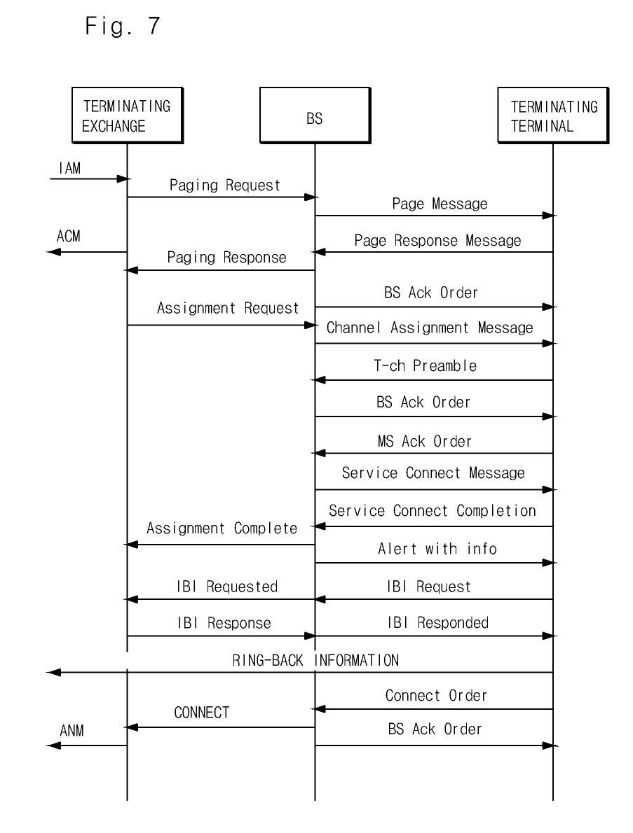

FIG. 7 is a call flow showing an example of inter-working between the terminating exchange 10-n and the terminating terminal 20-n, where new messages are introduced between them, when the present invention is applied to the mobile telecommunication network. Also, FIG. 7 shows the call processing procedures based on the 3GPP2 IOS Specifications (3GPP2 A.S0001-A version 2.0).

As shown in FIG. 7, upon receiving the IAM from the originating exchange, the terminating exchange transmits a Paging Request Message to the base station controller (BSC). In response to a Channel Assignment Request from the terminating exchange, the BSC transmits the Channel Assignment Message to the terminating terminal. And in response to the Service Connect Completion Message from the terminal, the BSC transmits the Channel Assignment Completion Message to the terminating exchange, and at the same time transmits to the terminal an ‘Alert with Info’ message for instructing the terminal to generate a ring tone. These procedures are the same as the normal scenario.

Meanwhile, in the present invention shown in FIG. 7, when receiving an Alert with Info message from the BSC, the terminating terminal informs the called party that the call request is present by generating a ring tone and at the same time transmits IBI Request Message indicating that the terminating terminal wants to transmit the RBI toward the originating terminal. Then the BSC transmits to the terminating exchange an IBI Requested Message informing that there is an IBI request from the terminal.

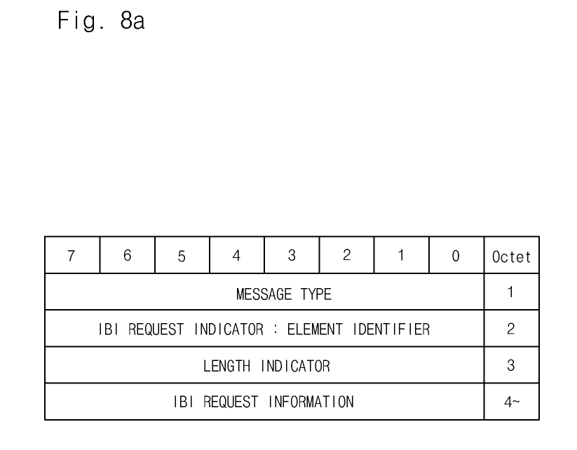

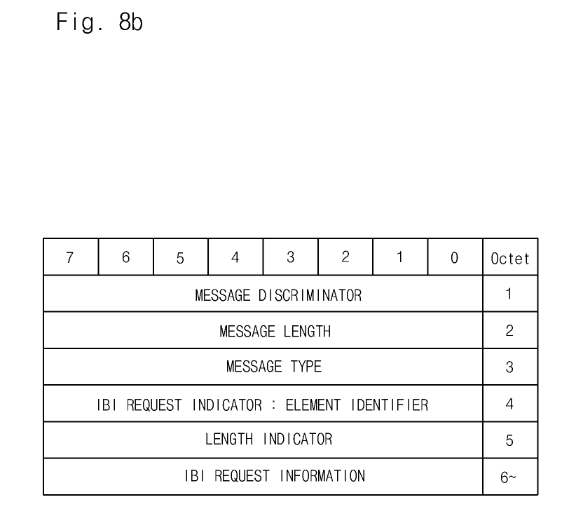

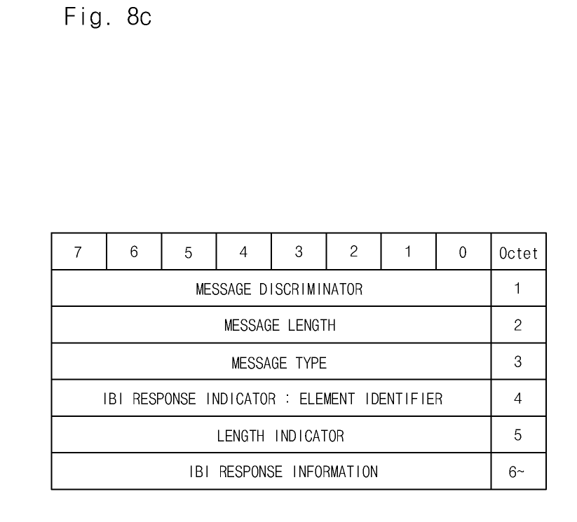

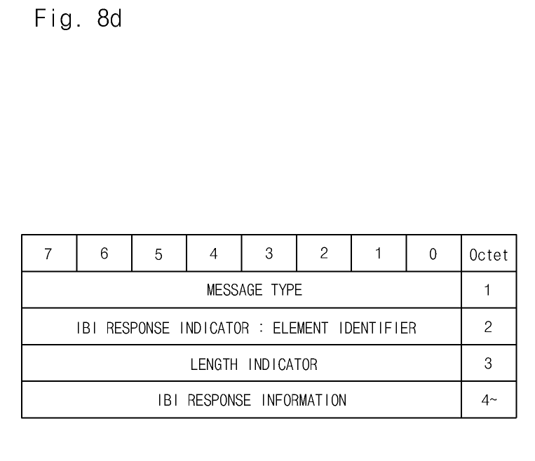

FIG. 8a is a message format showing an example of configuration of IBI Request Message above. The IBI Request Message in FIG. 8a has one byte of Message Type information. A peculiar value indicating that the message concerned is IBI Request Message is allotted to the Message Type information. And the IBI Request Indicator is included in it. The IBI Request Indicator contains the Element Identifier, the Length Indicator and the IBI Request Information, like the message structure as shown in FIG. 4a. The IBI Request Information field can contain the RBI type which will be transmitted from the terminating terminal 20-n.

FIG. 8b is a message format showing an example of configuration of IBI Requested Message. The IBI Requested Message in FIG. 8b has 2 bytes of BSMAP Message Header composed of Message Discriminator and Message Length fields, and one byte of Message Type information, like a normal message. A peculiar value indicating that the message concerned is IBI Requested Message is allotted to the Message Type information. And the IBI Request Indicator is included in it. The IBI Request Indicator contains Element Identifier, Length Indicator and IBI Request Information fields. This IBI Request Information can contain the RBI type that will be transmitted from the terminating terminal.

When receiving an IBI Requested Message from the BSC, the terminating exchange forms an IBI Response Message indicating whether it permits or rejects the transmission of RBI by the terminating terminal, and transmits it to the BSC.

At this time, the permission of RBI transmission by the terminating terminal is judged by whether the terminating terminal is registered in the service concerned, and also subscription of the service is judged by inquiring into the subscriber's profile information.

In case the terminating terminal is not registered in the service, the terminating exchange transmits to the BSC an IBI Response Message of rejecting transmission of RBI by the terminating terminal, and at the same time provides a normal ring-back tone for the originating terminal. On the other hand, in case the terminating terminal is registered in the service, the terminating exchange transmits to the BSC an IBI Response Message of permitting transmission of RBI from the terminating terminal, and at the same time connects the traffic channel so that the RBI can be delivered from the terminating terminal toward the originating terminal.

When receiving the IBI Response Message from the terminating exchange, the BSC transmits IBI Responded Message to the terminating terminal. Also, in case the IBI Response Message from the terminating exchange permits the transmission of RBI by the terminating terminal, the BSC connects the traffic channel so that the RBI can be delivered from the terminating terminal to the terminating exchange.

When receiving from the BSC an IBI Responded Message of permitting the transmission of RBI, the terminating terminal extracts the RBI from the storage device and then transmits it toward the terminating exchange through the BSC. The next procedures are the same as the normal call procedures.

FIG. 8c is a message format showing an example of configuration of IBI Response Message above. The IBI Response Message in FIG. 8c has 2 bytes of BSMAP Message Header composed of Message Discriminator and Message Length fields, and one byte of Message Type information.

A peculiar value indicating that the message concerned is IBI Response Message is allotted to the Message Type information. And the IBI Response Indicator is included in it. The IBI Response Indicator contains Element Identifier, Length Indicator and an IBI Response Information fields.

The IBI Response Information contains the information indicating whether the transmission of RBI by the terminating terminal is permitted or rejected, and as the case may be, it can contain the information indicating the type of RBI selectively.

FIG. 8d shows an example of configuration of IBI Responded Message above. The IBI Responded Message in FIG. 8d has one byte of Message Type information, like a normal message. A peculiar value indicating that the message concerned is IBI Responded Message is allotted to the Message Type information. And the IBI Response Indicator is included in it. This IBI Response Indicator contains Element Identifier, Length Indicator and IBI Response Information fields. Like the IBI Response Information in FIG. 8c, the IBI Response Information contains the information indicating whether the transmission of RBI by the terminating terminal is permitted or rejected, and as the case may be, it can contain the information indicating the type of RBI selectively.

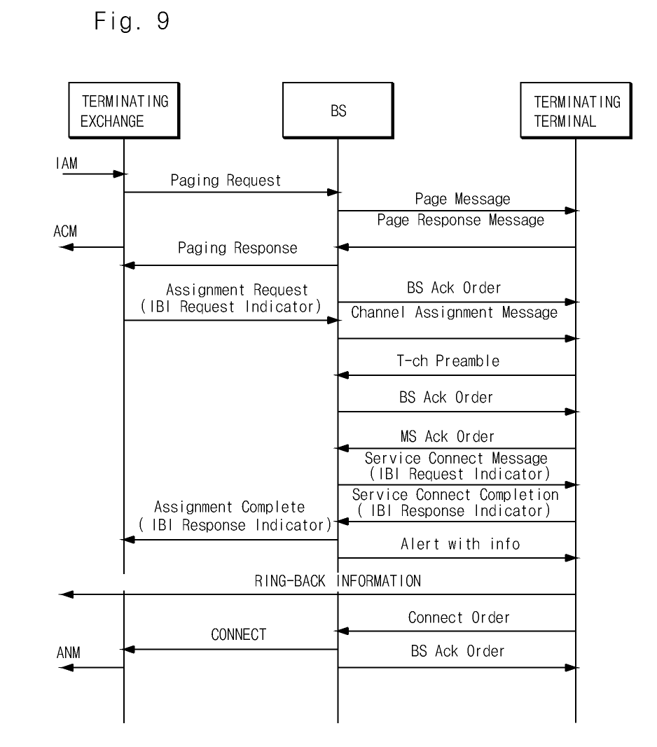

FIG. 9 is other example when the present invention is applied to the mobile communication network. This is an example of inter-working between the terminating exchange and the terminating terminal in which the existing messages are used between them.

As shown in FIG. 9, upon receiving a Paging Response Message from the BSC, the terminating exchange judges whether the terminating terminal is registered in the RBI service concerned by inquiring into the subscriber's profile information. And in case the terminating terminal is not registered in the service concerned, the terminating exchange processes the call as before; it transmits a normal ring-back tone toward the originating terminal by the time the called user answers the call.

On the other hand, in case the terminating terminal is registered in the service concerned, the terminating exchange transmits to the BSC an Assignment Request Message in which the IBI Request Indicator is included.

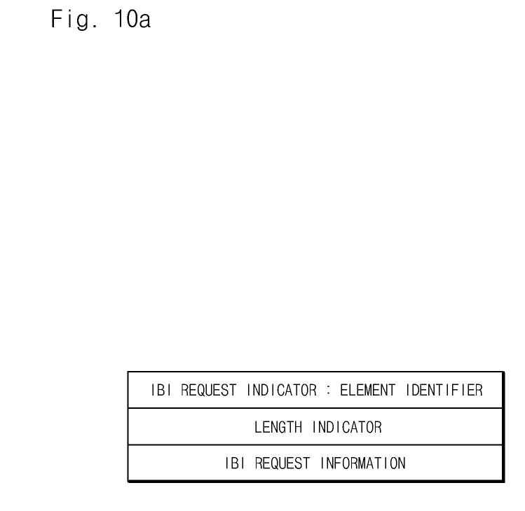

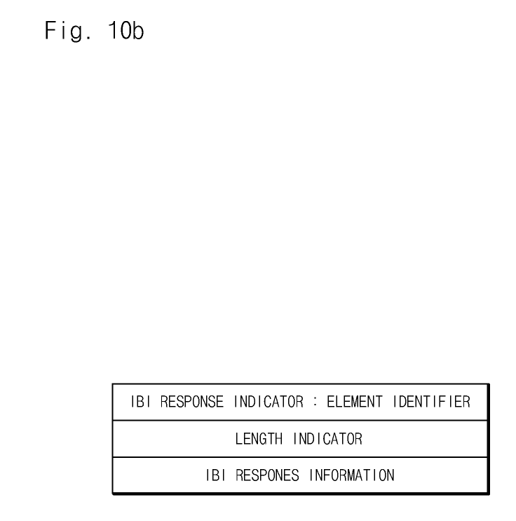

FIG. 10a shows an example of configuration of IBI Request Message above. The IBI Request Indicator has Element Identifier, Length Indicator and IBI Request Information fields. The IBI Request Information basically contains the information requesting or inquiring the transmission of RBI to the terminating terminal, and it can contain the type of information that can be provided as a substitute for the ring-back tone.

In case the IBI Request Indicator is included in the Assignment Request Message that is received from the terminating exchange, the BSC stores it in a certain storage device. As the storage device and the method to store messages or indicators received from the BSC are very common matters, the details are not described here.

Meanwhile, the BSC checks whether the above-mentioned IBI Request Indicator has been stored, at the time when a Service Connect Message is transmitted to the terminating terminal. In case the IBI Request Indicator is not stored, the normal call setup procedures are executed. On the other hand, in case the IBI Request Indicator is stored, the BSC includes the IBI Request Indicator in the Service Connect Message and then transmits it to the terminating terminal. The format of the IBI Request Indicator included in the Service Connect Message is practically the same as shown presented in the FIG. 10a.

When receiving the Service Connect Message in which the IBI Request Indicator is included from the BSC, the terminating terminal judges whether the terminating terminal itself transmits the RBI to the originating terminal directly. And the terminating terminal transmits to the BSC a Service Connect Completion Message including the IBI Response Indicator indicating whether the terminating terminal itself wants to transmit the RBI.

FIG. 10b shows an example of configuration of IBI Response Indicator above. The IBI Response Indicator has Element Identifier, Length Indicator and IBI Response Information fields. The IBI Response Information basically contains the information indicating whether the terminating terminal wants to transmit the RBI or not and optionally the information on the type of RBI.

When receiving the Service Connect Completion Message from the terminating terminal, the BSC transmits the Assignment Complete Message to the terminating exchange. At this time, in case the IBI Response Indicator is included in the Service Connect Completion Message, the IBI Response Indicator should be included in the Assignment Complete Message.

The IBI Response Indictor included in the Assignment Complete Message is practically the same as shown in FIG. 10b. Then the BSC transmits Alert with Info Message to the terminating terminal. Also, in case the IBI response Indicator included in the Service Connect Completion Message received from the terminating terminal indicates the transmission of RBI by the terminating terminal, the BSC connects the traffic channel so that the RBI can be delivered from the terminating terminal toward the originating terminal.

When receiving the Assignment Complete Message from the BSC, the terminating exchange judges whether the terminating terminal transmits RBI, based on the above IBI Response Indicator. And in case the terminating terminal executes the transmission of RBI, the terminating exchange connects the traffic channel from the terminating terminal toward the calling party so that the RBI can be delivered from the terminating terminal to the calling party. Of course, in case the IBI response Indicator is not included, or in case the IBI Response Indicator indicates that the terminating terminal does not want to transmit the IBI, the terminating exchange will generate and transmit the ring-back tone toward the calling party.

When receiving an ‘Alert with Info’ Message from the BSC, the terminating terminal generates the ring tone to inform the user that a call request is received and at the same time extracts the RBI from the storage device and transmits it to the BSC. The transmission of RBI is executed through the Reverse Traffic Channel set by the Channel Assignment Message received from the BSC.

And when the called party answers the call, the terminating terminal stops transmitting the RBI and at the same time executes a normal call connection procedure by transmitting the Connect Order Message to the BSC.

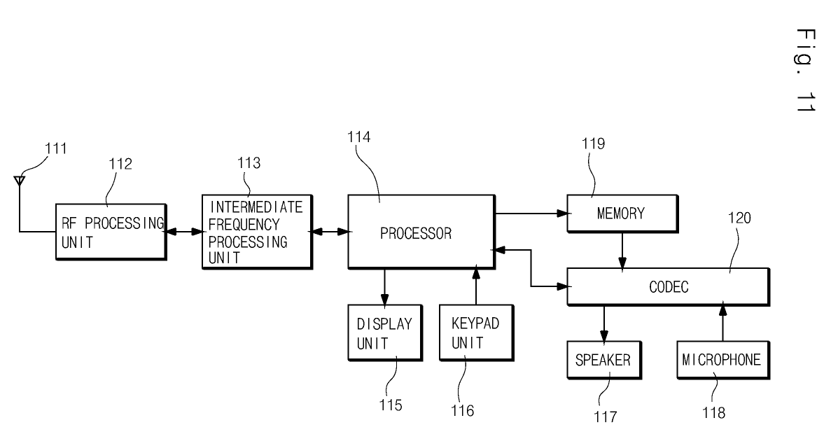

FIG. 11 is a block diagram showing an example of configuration of the terminal to which the present invention is applied, especially, for mobile communication system corresponding to FIG. 7 and FIG. 9. As shown in FIG. 11, the reference numeral 111 is an antenna. 112 is RF processing unit which amplifies the high frequency signal received from the BSC through the antenna 111 and converts it into the intermediate frequency signal, and converts the intermediate frequency signal received from the Intermediate frequency processing unit 113 into high frequency, amplifies it and transmits it to the antenna 111. The Intermediate frequency processing unit 113 converts the intermediate frequency signal received from the RF processing unit 112 into a base band signal, delivers it to the processor 114, and converts the base band signal received from the processor 114 into intermediate frequency signal and sends it to the RF processing unit 112.

Also, reference numeral 114 is the processor that controls the whole device. The processor 114 is, for example, a MSM modem chip manufactured by Qualcomm Co., Ltd., and it basically has the signal processing function for the base band signal and also the processors for executing various kinds of programs, and can execute the control functions as programmed. As stated above, the processor 114 controls the transmission of RBI toward the calling party by processing the messages exchanged with the BSC.

Reference numeral 115 is a Display Unit such as LCD display panel. 116 is a keypad which has various kinds of operation keys including 10-keys. And 117 is a speaker which converts the electric sound signal into the audible sound and outputs it. Reference numeral 118 is the microphone that converts the audible sound into the electric signal. Reference numeral 120 is a codec that encodes the electric analog sound signal into digital data or decodes the sound data into the analog sound signal.

And the reference numeral 119 is the memory that stores the RBI such as music, songs, advertisements, sounds, voices, any audible resource edited by the subscriber, animation, moving images, and so on.

Hereafter, the operation of the above-mentioned device is described.

First of all, storing of RBI in the above memory 119 can be executed in the normal manner. For example, a user may connect the terminal to a separate server for providing RBI to select and download the RBI from the server into the memory 119, or store any RBI into the memory 119 through a port (not illustrated in the figure) in the terminal.

After storing a certain RBI in the memory 119, the user can input the optional information for or in connection with the RBI Service by handling the keypad 116. And the information selected by the user will be stored in the status storage unit (not illustrated in the Figure). The above optional information can be formed in a variety of types. For example, the RBI can be changed according to the calling party's telephone number or according to the time a call is received. In case the user cannot answer the phone call during the certain time, for example, to attend a meeting or to drive a car, the terminal can be set to provide the RBI like “I am sorry, but I can't answer your phone call now. Please call me back after 3 o'clock.”

As shown in FIG. 7, when receiving an ‘Alert with Info’ Message from the BSC, the processor 114 judges whether the processor itself executes the transmission of RBI by inquiring into the status storage unit. And in case the processor executes the transmission, it creates an IBI Request Message and then transmits it to the BSC.

Then, when receiving the IBI Response Message of permitting the transmission of RBI from the BSC, the processor 114 extracts the RBI from the memory 119, and codes it through the Codec 120 and then transmits it toward the terminating exchange.

Of course, the processor 114 can select the RBI based on, for example, the originating number received from the terminating exchange. When receiving an IBI Response Message of rejecting the transmission of RBI from the BSC, the processor 114 executes the normal procedures. In this case, it can display the information message through the display unit 115 indicating that the RBI service is rejected.

When receiving a Service Connect Message in which IBI Request Indicator is included from the BSC as shown in FIG. 9, the processor 114 judges whether the processor itself executes the transmission of RBI by inquiring into the status storage unit. And based on the result of judgment, the processor 114 forms the Service Connect Completion Message in which the IBI Response Indicator is included and transmits it to the BSC. In case the transmission of RBI is executed as a result of the judgment, when receiving an ‘Alert with Info’ Message from the BSC, the processor 114 extracts the appropriate RBI from the memory and codes it through the codec 120, and then transmits it to the terminating exchange. Of course, the processor 114 can choose the RBI selectively, for example, according to the originating number received from the terminating exchange.

In case the RBI transmission function is not activated or in case it does not correspond to the RBI transmission conditions, the processor 114 creates a Service Connect Completion Message with IBI Response Indicator indicating no transmission of RBI and transmits it to the BSC. Hereafter, the normal processing procedures are executed.

In case the terminating terminal does not receive the IBI Request Indicator from the BSC in FIG. 9, it executes the normal terminating call procedures from that time. And in case the RBI transmission function is set in the terminal but the IBI Request Indicator is not received or in case the RBI transmission conditions set between the terminal and the exchange are not inconsistent, a certain information can be provided through the display unit 115 to inform the user that the RBI service is not possible for the call.

According to the application of the present invention as stated above, the RBI can be directly transmitted to the originating terminal from the terminating terminal, even with the minimized change of the existing systems.

Besides, the present invention is not limited to the application as described above, and it can be variously applicable within the range of the technical points of the present invention. For example, the present invention describes some examples applied to ISDN and mobile network, however, it can be applicable to all existing telecommunication network in the same manner.

It is described in the above that the RBI is selectively provided from the terminating terminal to the originating terminal, based on the request for RBI transmission from the terminating exchange or for IBI permission from the terminating terminal. The present invention can be also materialized so that the exchange can unconditionally deliver the RBI from the terminating terminal to the originating terminal. In addition, the present invention can be also materialized so that the exchange judges whether the terminal concerned is subscribed to the RBI service based on the profile information on the terminating terminals, and in case the terminal is subscribed, the exchange provides the originating terminal with the RBI permitted by the terminating terminal.

It is also described in the above that the RBI is selectively provided from the terminating terminal to the originating terminal, by adding the new messages to the specific locations in the middle of call processing procedures or by adding the new information elements to the specific messages. However, in the present invention, the message or information element added to transmit the RBI from the terminating terminal, if necessary, can be located at any location in the middle of call processing without limitation.

In addition, it is described in the above that messages or elements on both permission and rejection are exchanged. However, the present invention can be configured to transmit messages or information elements, only if the transmission of RBI is possible or only if the transmission of RBI is rejected.

### INDUSTRIAL APPLICABILITY

As described in detail above, the present invention provides a method, system and communication terminal, which can provide a variety of RBI during the call setup time for the calling party, even with the minimized change of the communication network.

1. A method for providing a variety of RBI from the terminating terminal to the originating terminal during the call setup time in the communication system that includes lots of terminals and the exchanges controlling the connection of communication paths between terminals, the method comprising the steps of:
a communication network receives a call setup request from the originating terminal;
the network notifies the terminating terminal that a call request is received, in response to the call request from the originating terminal;
the terminating terminal transmits the RBI to the network; and
the network delivers to the originating terminal the RBI received from the terminating terminal.

2. A method for providing a variety of RBI from the terminating terminal to the originating terminal during the call setup time as recited in claim 1, wherein further includes the step:
The terminating terminal requests the network to permit the transmission of RBI; and,
in case there is a request for permit of RBI transmission from the terminating terminal, the network decides whether to accept the request or not, and then inform the terminating terminal of it.

3. A method for providing a variety of RBI from the terminating terminal to the originating terminal during the call setup time as recited in claim 1, wherein further includes the step:
the network requests the terminating terminal to transmit the RBI; and,
in case there is a request for RBI transmission from the network, the terminating terminal decides whether to transmit the RBI or not, and then informs the network of it.

4. A method for providing a variety of RBI from the terminating terminal to the originating terminal during the call setup time as recited in claim 1, wherein the network selectively provides the originating terminal with the RBI transmitted from the terminating terminal.

5. A system for providing a variety of RBI from the terminating terminal to the originating terminal during the call setup time in the communication system comprising lots of terminals and the network controlling the connection of communication paths between terminals, wherein;
terminals that transmit RBI to the network, in case there is a call request from the network during the call setup time, and
the network that delivers the originating terminal with the RBI transmitted from the terminating terminal during the call setup time.

6. A system for providing a variety of RBI from the terminating terminal to the originating terminal during the call setup time in the communication system as recited in claim 5, wherein the network selectively permits the transmission of the RBI from the terminating terminal based on the profile information of the terminating terminal.

7. A system for providing a variety of RBI from the terminating terminal to the originating terminal during the call setup time in the communication system as recited in claim 5, wherein the terminal includes;
a storage means for storing a variety of RBI, and
a control means for controlling the transmission of RBI to the network, where a variety of RBI is stored in the above-mentioned storage means.

8. A system for providing a variety of RBI from the terminating terminal to the originating terminal during the call setup time in the communication system as recited in claim 7, wherein the terminal further includes;
an optional control means by which a user can select the transmission of RBI at his option.

9. A system for providing a variety of RBI from the terminating terminal to the originating terminal during the call setup time in the communication system as recited in claim 7, wherein the above-mentioned control means selects and transmits the RBI, corresponding to the caller's number.

10. A communication terminal for providing a variety of RBI during the call setup time in the communication system, wherein includes;
a sound input means,
a sound output means,
a key input means for putting the telephone numbers in,
a communication network interface means for connecting with communication network,
a storage unit for storing a variety of RBI, and
a control means for controlling the transmission of the RBI stored in the storage means to the communication network during the call setup time, in case the terminal receives a call request from the communication network.

11. A communication terminal for providing a variety of RBI during the call setup time in the communication system as recited in claim 10, wherein further includes;
an optional means by which a user can select the transmission of RBI at his option.

12. A communication terminal for providing a variety of RBI during the call setup time in the communication system as recited in claim 10, wherein the control means transmits the RBI, corresponding to the caller's telephone number.

13. A communication terminal for providing a variety of RBI during the call setup time in the communication system as recited in claim 10, in which the control means requests the permission of RBI transmission, in case there is a call request from the communication network, and, when permitted, it controls the transmission of RBI to the communication network.

14. A communication terminal for providing a variety of RBI during the call setup time in the communication system as recited in claim 13, in which the control means informs the user of the rejection, in case the communication network rejects the request for permission of RBI transmission.
